(19) United States
(12) Patent Application Publication
(10) Pub. No.: US 2006/0148508 A1
(43) Pub. Date: Jul. 6, 2006

(54) Apparatus and method for controlling outer loop power

(76) Inventors: Hoo-Young Jeong, Seongnam (KR); Sung-Lark Kwon, Seoul (KR); Hong-Jik Kim, Seoul (KR); Hee-Gul Park, Anyang (KR)

Correspondence Address: FLESHNER & KIM, LLP, P.O. BOX 221200, CHANTILLY, VA, 20153, US

(21) Appl. No.: 11/318,513

(22) Filed: Dec. 28, 2005

(30) Foreign Application Priority Data
Dec. 30, 2004 (KR) 116561/2004

(51) Int. Cl. H04B 7/00

(52) U.S. Cl. 455/522; 455/69

(57) ABSTRACT

A communication system having multiple channels is disclosed. An apparatus for controlling outer loop power in the communication system having the multiple channels includes a step adjustment unit for re-setting height of a step size for power controlling with reference to a CRC result, when the CRC result is received from a base station; and a power controller for determining a target signal to interference ratio (SIR) with reference to the CRC result and the re-set step size information, and transmitting the determined target SIR to the base station. Power controlling operation can be more effectively performed in the communication system having the multiple channels.

### BACKGROUND OF THE INVENTION

1. Field of the Invention

The present invention relates to power controlling of a mobile communication system and, more particularly, to an apparatus and method for controlling an outer loop power in a mobile communication system having multiple channels.

2. Description of the Related Art

In general, users share time and frequencies in a CDM (Code Division Multiple Access) environment, so signals of each user interfere each other and thus system capacity is controlled by the amount of interference.

In the CDMA environment, a system provides communication quality of a certain level or higher by allocating minimum power to each terminal of a cell through power controlling. The communication quality refers to a block error rate (B ER).

In uplink, the system solves a near-far problem by controlling power of each terminal so that the same power of signals of each user can be received by a Node B. In downlink, which is free from the near-far problem, the system can allocate more power to a terminal (user equipment (UE)) located far away from the Node B or a terminal which receives a weak signal due to fading.

FIG. 1 is a schematic block diagram showing a communication system having multiple channels.

As shown in FIG. 1, the communication system having the multiple channels comprises a RNC (Radio Network Controller) 100 including an outer loop power controller 110, a Node B 200 including a CRC (Cyclic Redundancy Check) checking unit 230, a receiving unit 210 and a power adjustment unit 220; and a terminal (UE) 300 including a power adjustment unit 320 and a receiving unit 310.

Transmission power in a communication section (first section) between the terminal 300 and the Node B 200 is controlled according to an inner loop power controlling method. Transmission power in a communication section (second section) between the Node B 200 and the RNC 100 is controlled according to an outer loop power controlling method.

FIG. 2 is a schematic block diagram showing the RNC 100 in the communication system.

As shown in FIG. 2, the apparatus for controlling power of outer loop power in accordance with a related art includes a plurality of outer loop power is controls (OLPCs) 110 for performing outer loop power controlling by using a CRC result received from the Node B 200 and outputting each target SIR (Signal to Interference Ratio), and a maximum value selecting unit 120 for receiving the target SIRs outputted from the plurality of OLPCs 110, selecting a maximum value and transmitting it to the Node B 200.

Power controlling in the related art with reference to the communication system having the multiple channels will now be described in detail.

First, in case of the inner loop power controlling performed in a first section, the Node B 200 measures (estimates) an SIR and compares the measured (estimated) SIR (or SIRₑₛₜ) with a target SIR (or SIR_{target}). If the SIRₑₛₜ is greater than SIR_{target}, the Node B 200 transmits a transmission power control (TCP) bit of 0 to the terminal 300, whereas if the SIRₑₛₜ is smaller than SIR_{target}, the Node B 200 transmits a TPC bit of 1. Namely, in order to match quality of a channel connected with the terminal 300 to the target SIR, the Node B 200 transmits the TPC bit to the terminal 300 at 1,500 Hz.

When the TPC bit is received by the terminal 300, the power adjustment unit 320 of the terminal adjusts (increases or decreases) transmission power (P(k)) with reference to the TPC bit. Equation (1) shown below is used to adjust the transmission power of the terminal:

$$P ( k ) = P ( k - 1 ) + {P}_{TPC} ( k ) , \\ ( k \text{:} arbitrary constant ) \\ {P}_{TPC} ( k ) = \{ \begin{matrix}+ {Δ}_{TPC} & if {TPC}_{est} ( k ) = 1 \\ - {Δ}_{TPC} & if {TPC}_{est} ( k ) = 0\end{matrix} , \\ ( {TPC}_{est} \text{:} estimated TPC ) \qquad ( 1 )$$

As for the power controlling (outer loop power controlling) performed at a second section in FIG. 1, in order to maintain communication quality of a certain level or higher, the target SIR is adjusted. In this case, the target SIR is determined in the RNC 100 and then transmitted to the Node B 200.

According to CRC check results, if there is no error (CRC=‘OK’), the system decreases the target SIR, whereas if there is an error (CRC=‘Error’), the system increases the target SIR. Step sizes of increasing and decreasing the transmission power is Delta_up (+Δ) and delta_down(−Δ), respectively, and height (adjustment width) of the step size varies depending on an FER (Frame Error Rate). The above descriptions can be expressed by equation (2) shown below:

When CRC is ‘OK’:
Target SIR=Target SIR−Delta_down

When CRC is ‘Error’:
Target SIR=Target SIR+Delta_up
Delta_up=K×Delta_down (2)

If a channel environment maintains a certain state and the target SIR also maintains almost a balanced state, the conditions of equation (3) shown below must be satisfied:
Delta_down×BLER=Delta_up×(1−BLER) (3)

A factor value (K) satisfying the condition can be expressed by equaltion (4) shown below:
K=1/BLER−1 (4)

When several transport channels are connected to a single physical channel, each transport channel can have each different communication quality and transmits a signal according to each different coding method and interleaving depth.

In addition, although each transport channel separately performs the outer loop power control function, they must use the same target SIR. Herein, if a combination ratio is properly set by rate matching, although a power control function is operated by a single channel, quality of every channel can be satisfied.

If target SIRs satisfying communication quality required by each channel are different but satisfy quality of every channel, some channels would have superior quality to a requested level. The maximum value selecting unit 120 compares the target SIRs generated by the respective outer loop power controllers 110 and sets the greatest value as a target SIR.

To begin with, a step size (Delta_up) for increasing power of each channel can be set to certain values as follows:

Channel 1: Delta_down_{—}1=1/K×Delta_up_{—}1

Channel 2: Delta_down_{—}2=1/K×Delta_up_{—}2

Channel N: Delta_down_n=1/K×Delta_up_n

The target SIR is adjusted according to each CRC result of each channel, and the highest target SIR is selected from the adjusted target SIRs and then transmitted to the base station 200.

In the related art, however, since power controlling is performed according to a channel which requests the highest target SIR, only a target BLER of the channel is satisfied while power of more than necessary is provided to the other remaining channels. That is, excessive convergence occurs at the remaining channels.

As stated above, in the related art, power controlling is performed such that transmission power is adjusted according to the target SIR of one of several channels. When a CRC error is detected, the target SIR is increased, and if there is no detected error, the target SIR is lowered.

However, in the communication system having the multi-channel environment in which several transport channels are connected to a single physical channel such as the WCDMA (Wideband Code Division Multiple Access) system, the related art power control method can set the similar target SIR satisfying the target BLER of each channel by effectively setting a power ratio between channels but it is difficult to accurately match every channel environment. In addition, a problem arises that the target SIR does not react to an error of a different channel, namely, errors are collectively generated.

### BRIEF DESCRIPTION OF THE INVENTION

Therefore, an object of the present invention is to provide an apparatus and method for controlling outer loop power capable of effectively performing power controlling in a communication system in which several transport channels are connected to a single physical channel.

To achieve at least the above objects in whole or in parts, there is provided an apparatus for controlling outer loop power in a communication system having multiple channels, comprising: a step adjustment unit for re-setting height of a step size for power controlling with reference to a CRC result, when the CRC result is received from a base station; and a power controller for determining a target signal to interference ratio (SIR) with reference to the CRC result and the re-set step size information, and transmitting the determined target SIR to the base station.

Preferably, the step adjustment unit measures a block error rate (BLER) of channels by using a CRC check result of each channel, checks whether the measured BLER of each channel satisfies a target BLER, and re-sets height of the step size for adjusting the target SIR according to the checking result.

Preferably, if the measured BLERs of every channel satisfies the target BLER, the step adjustment unit changes to a value corresponding to a BLER higher than a height weight value of the step size, and if there is at least one channel which does not satisfy the target BLER, the height weight value is changed to a value corresponding to a lower BLER.

Preferably, in order to measure the BLER of each channel, the step adjustment unit sets a window of a certain size for storing the CRC results, detects the number of CRC errors and an interval between block errors, and measures the BLER of each channel with reference to the detected number of CRC errors and the detected interval between the block errors.

To achieve at least these advantages in whole or in parts, there is further provided a method for controlling power of a base station control system of a communication having multiple channels, comprising: re-setting height of a step size for controlling power with reference to a CRC result when the CRC result is received from a base station; and determining a target SIR with reference to the CRC result and the re-set step size information, and transmitting the determined target SIR to the base station.

Preferably, the re-setting step comprises: measuring a BLER of each channel by using CRC check results of each channel; checking whether the measured BLER of each channel satisfies a target BLER; and re-setting height of the step size adjusting the target SIR according to the checking result.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic general block diagram showing the construction of a communication system having multiple channels;

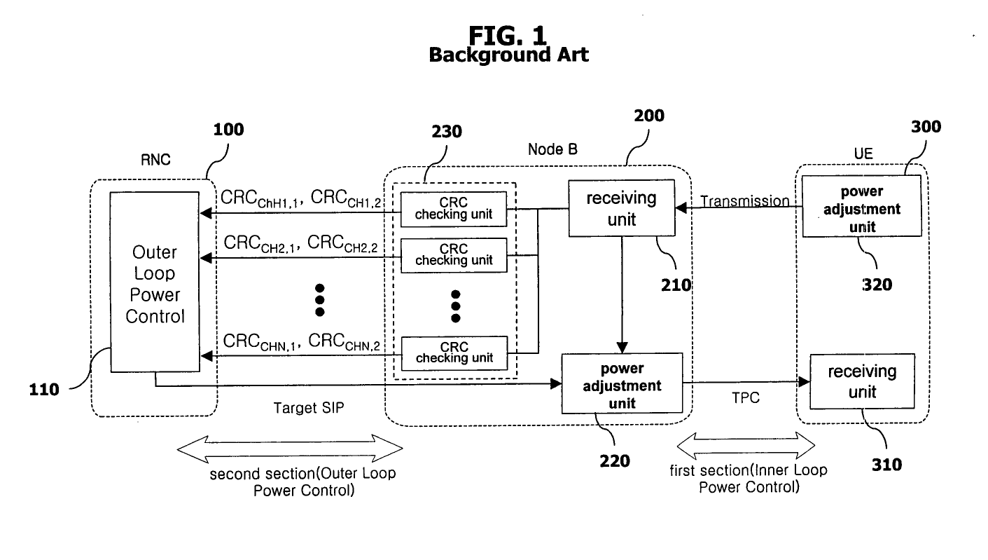

FIG. 2 is a schematic block diagram showing the construction of an apparatus for controlling outer loop power in accordance with a related art;

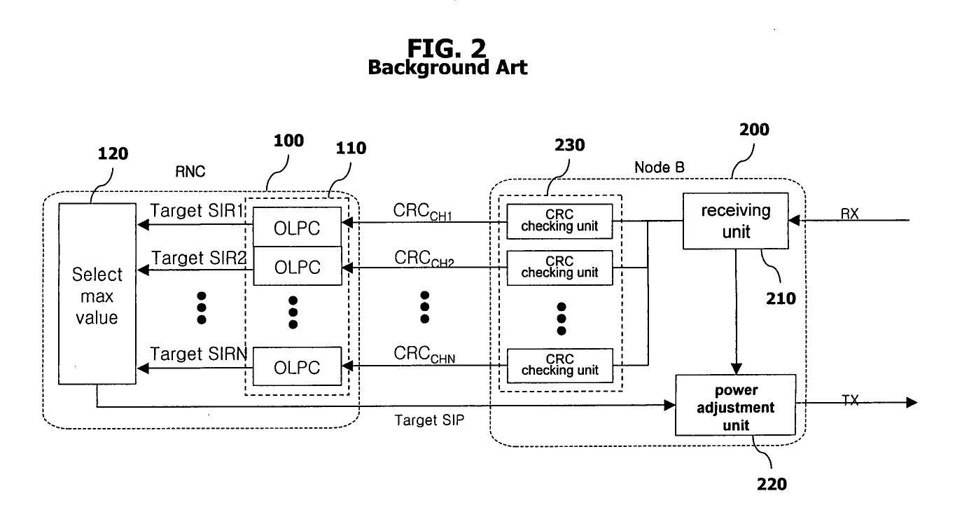

FIG. 3 is a schematic block diagram showing the construction of an apparatus for controlling outer loop power in accordance with the present invention; and

FIG. 4 is a flow chart illustrating the processes of controlling the outer loop power in accordance with the present invention.

### DETAILED DESCRIPTION OF THE INVENTION

The present invention is designed to determine a target SIR by using a result obtained by checking a CRC of every channel.

The present invention will now be described with reference to the accompanying drawings.

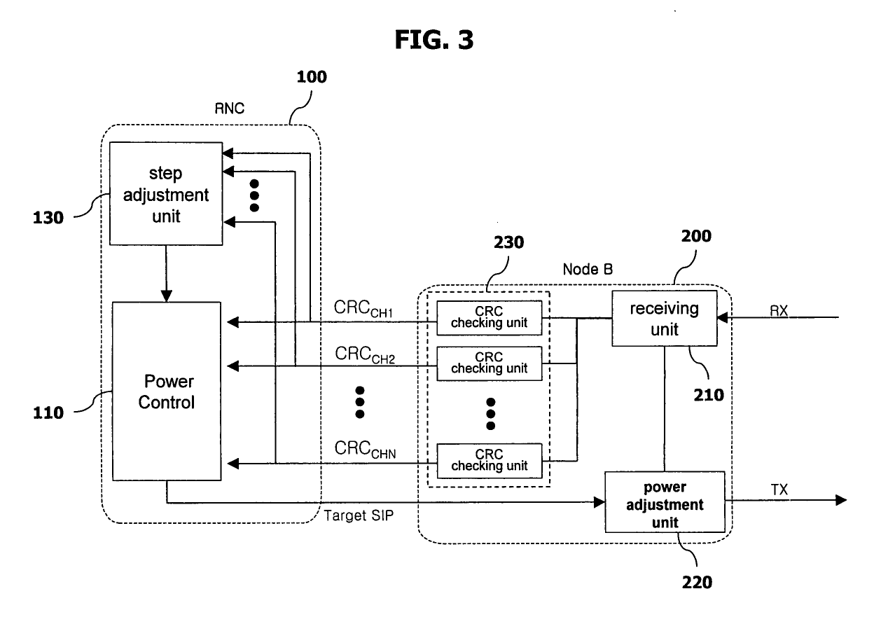

FIG. 3 is a schematic block diagram showing the construction of an apparatus for controlling outer loop power in accordance with the present invention.

As shown in FIG. 3, the apparatus for controlling power in accordance with is the present invention includes a step adjustment unit 130 for re-setting height of a step size for controlling power with reference to a received CRC result; and a power controller 110 for determining a target SIR with reference to the CRC result and the re-set step size information, and transmitting the determined target SIR to a base station 200. Power controlling in accordance with the present invention will now be described with reference to FIG. 3.

The present invention determines a target SIR by using a result obtained by checking of a CRC of every channel. This is a concept extending a method applied when there are several transmission blocks in one channel.

When the target SIR is determined, parameters (Delta_up(+Δ), Delta_down(−Δ)) are adjusted according to each target SIR.

Channel 1: Delta_down_{—}1=1/K×Delta_up_{—}1

Channel 2: Delta_down_{—}2=1/K×Delta_up_{—}2

Channel N: Delta_down_N=1/K×Delta_up_N

The target SIR is determined at every TTI (Transmission Time Interval) according to every CRC result as expressed by equation (5):

$$Sum\_delta = {\sum }_{j}^{N\_TrCH} \{ [ ( 1 - {CRC}_{j} ) ⨯ Delta\_up ] - [ {CRC}_{j} ⨯ Delta\_down \_j ] \}$$

$$wherein {CRC}_{j} = \{ \begin{matrix}1 & : CRC is {}_{}^{′}{OK}{}_{}^{′} \\ 0 & : CRC is {}^{′} not {OK}^{′}\end{matrix} and N\_TrCH is the number of transport channels .$$

When Sum_Delta is obtained by equation (5), the target SIR is determined by equation (6) shown below:
Target SIR=Target SIR+Sum_Delta (6)

The matters described above consider the fact that TTI of every channel is the same. In this respect, however, each transport channel can have a different TTI, namely, a data transmission unit time.

Considering that each transport channel has a different TTI, one channel may obtain a single CRC result while another channel can obtain several CRC results in a specific section. In the 3GPP WCDMA system, TTIs of 10 ms, 20 ms, 40 ms and 80 ms are considered to be desirous.

In the case where the TTI of each transport channel is different, the target SIR is adjusted according to a time point at which each CRC result is obtained. When the TTI of each transport channel is different and the target SIR satisfying quality of each channel is different, the sum of BLER of every channel is not converged into the target SIR satisfying the target BLERs of every channel but converted into the sum of the target BLERs. According to circumstances, quality of one channel may be better than target quality while quality of another channel may be worse than the target quality.

Thus, in order to avoid such a phenomenon, a parameter (Weight_Delta) has been newly introduced. In the present invention, if there is at least only one channel which fails to satisfy the target BLER among the transport channels, the step adjustment unit 130 re-sets height of the step size (Delta_up and Delta_down) which adjusts the target SIR. By re-setting the height of the step size, an effect of adjusting the target BLER of every transport channel.

Namely, if every transport channel satisfies the target BLER, a height weight value (weight_Delta) of the step size which adjusts the target SIR to a value corresponding a higher BLER, whereas if there is at least one of the channels which fails to satisfy the target BLER, the step adjustment unit 130 changes the height weight value (weight_Delta) to a value corresponding to a lower BLER. For this purpose, the step adjustment unit 130 measures a BLER of each channel at a certain time interval.

An algorithm of the present invention with respect to the kth transport channel can be expressed as follows:

If BLER_{target}_{_{—}}k > BLER_{measured}_{_{—}}k,
BLER_k = OK;
Else BLER_k ≠OK.

In the present invention, in order to measure the BLER of each channel, a window of a certain size for storing the CRC results is set and the number of CRC errors or the space between block errors is detected in the set window. And then, the BLER is estimated (or measured) with reference to the detected number of CRC errors or the space between the block errors. If every transport channel satisfies the measured BLER_k (BLER_k=OK), the height weight value (Weight_Delta) is obtained according to equation (7) shown below:
Weight_Delta=Weight_Delta×Weight_down (7)

Meanwhile, even if there is only one channel which does not satisfy the measured BLER (BLER_k≠OK), the height weight value (Weight_Delta) is obtained by equation (8) shown below:
Weight_Delta=Weight_Delta×Weight_up (8)

In the present invention, an initial value of the height weight value (Weight_Delta) is set as ‘1’. The Weight_down is set as a value smaller than 1, while the Weight_up is set as a value greater than ‘1’. A relationship between the Weight_down and Weight_up can be expressed by equation (9) shown below:
Weight_down=1/Weight_up (9)

Thereafter, when the height weight value (weight_Delta) is obtained by equations (7) and (8), the step adjustment unit 130 re-sets the height of the step size (Delta_up(+Δ) or Delta_down(−Δ)) which adjusts the target SIR expressed by equation (10) shown below:
Delta_down=Delta_down×Weight_Delta
Delta_up=Delta_up×Weight_Delta (10)

In the present invention, by adding specific parameters (hist 1 and hist 2) to the algorithm for determining whether the measured BLER satisfies the target BLER, unnecessary variations in transmission power can be prevented.

```
If BLER_{target}_{_{—}}k > BLER_{measured}_{_{—}}k + hist1,
    BLER_k = OK;
Else if BLER_{target}_{_{—}}k > BLER_{measured}_{_{—}}k + hist2
    BLER_k ≠ OK.
```

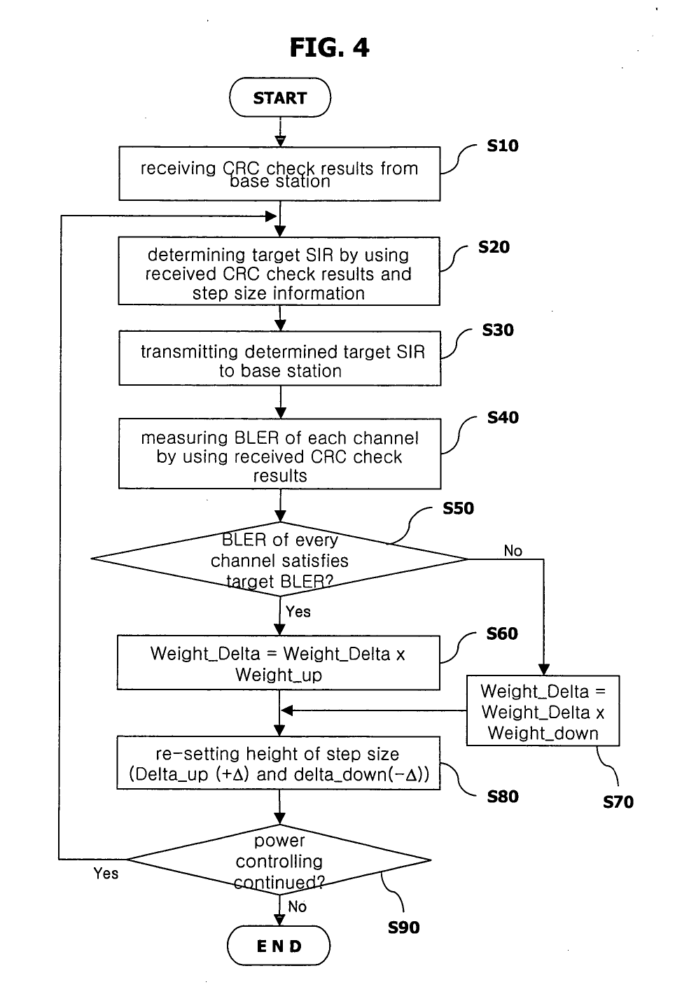

FIG. 4 is a flow chart illustrating the processes of controlling the outer loop power in accordance with the present invention.

The base station 200 receives the transmission blocks from a terminal, checks CRCs (Cyclic Redundancy Checking), and then transfers information regarding the result of the CRC checking to the base station control system (e.g., RNC 100) (step S10).

As shown in FIG. 4, as the CRC check result is received by the RNC 100 from the base station 200, the power controller 110 determines the target SIR by using the CRC check results as expressed equations (5) and (6) (step S20). And then, the power controller 110 transmits the determined target SIR to the base station 200 so that the base station 200 can control transmission power of the terminal (step S30). Then, the power adjustment unit 220 transmits TPC bits to the terminal 300 with reference to the target SIR, and the power adjustment unit 320 of the terminal adjusts (increases or decreases) the transmission power with reference to the received TPC bits.

The step adjustment unit 130 measures a BLER of each channel by using the CRC check results of each channel, and determines whether the BLER of each channel satisfies the target BLER (steps S40 and S50). And then, according to the determining result, the step adjustment unit 130 re-sets the height of the step size (Delta_up(+Δ) or Delta_down(−Δ)) which adjusts the target SIR (steps S60˜S80).

If every transport channel satisfies the target BLER, the step adjustment unit 130 changes the height weight value (weight_Delta) of the step size (Delta_up(+Δ) or Delta_down(−Δ)) to a value corresponding to a higher BLER (step S60), whereas if there is at least one of the channels which fails to satisfy the target BLER, the step adjustment unit 130 changes the height weight value (weight_Delta) to a value corresponding to a lower BLER (step S70).

When the height weight value (weight_Delta) of the step size is obtained through the steps S60 and S70, the step adjustment unit 130 re-sets the height of the step size (Delta_up(+Δ) or Delta_down(−Δ)) as expressed in equation (10) (step S80), and then, transfers the re-set step size information to the power controller 110.

Thereafter, when the CRC check result is received by the base station control system (namely, the RNC 100), the power controller 110 determines the target SIR with reference to the step size information and the CRC check result. As so far described, the present invention performs more effective power controlling operation in the communication system having the multiple channels.

In addition, when there are several blocks in a single TTI, a desired BLER can be obtained by using the CRC result of each block. In addition, when there are several transport channels using the same target SIR, a desired target BLER can be satisfied by controlling the outer loop power.

Moreover, since it reacts to the CRC results of every channel, the problem that block errors are successively generated can be solved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An apparatus for controlling outer loop power in a communication system having multiple channels, comprising:
a step adjustment unit for re-setting height of a step size for power controlling with reference to a CRC result, when the CRC result is received from a base station; and
a power controller for determining a target signal to interference ratio (SIR) with reference to the CRC result and the re-set step size information, and transmitting the determined target SIR to the base station.

2. The apparatus of claim 1, wherein the step adjustment unit and the power controller are provided in a base station control system.

3. The apparatus of claim 1, wherein the step adjustment unit measures a block error rate (BLER) of each channel by using a CRC check result of each channel, checks whether the measured BLER of each channel satisfies a target BLER, and re-sets height of the step size for adjusting the target SIR according to the checking result.

4. The apparatus of claim 3, wherein if the measured BLERs of every channel satisfies the target BLER, the step adjustment unit changes to a value corresponding to a BLER higher than a height weight value of the step size, and if there is at least one channel which fails to satisfy the target BLER, the height weight value is changed to a value corresponding to a lower BLER.

5. The apparatus of claim 2, wherein in order to measure the BLER of each channel, the step adjustment unit sets a window of a certain size for storing the CRC results, detects the number of CRC errors and an interval between block errors, and measures the BLER of each channel with reference to the detected number of CRC errors and the detected interval between the block errors.

6. The apparatus of claim 5, wherein the step adjustment unit measures the BLER of each channel at certain time intervals.

7. The apparatus of claim 1, wherein if a TTI (Transmission Time Interval) of each transport channel is different, the power controller determines a target SIR at a time point when each CRC result is obtained.

8. A method for controlling power of a base station control system of a communication having multiple channels, comprising:
re-setting height of a step size for controlling power with reference to a CRC result when the CRC result is received from a base station; and
determining a target SIR with reference to the CRC result and the re-set step size information, and transmitting the determined target SIR to the base station.

9. The method of claim 8, wherein the re-setting step comprises:
measuring a block error rate (BLER) of each channel by using CRC check results of each channel;
checking whether the measured BLER of each channel satisfies a target BLER; and
re-setting the height of a step size which adjusts the target SIR according to the checking result.

10. The method of claim 9, wherein if the measured BLER of every channel satisfies the target BLER, a height weight value of the step size is changed to a value corresponding to a higher BLER.

11. The method of claim 9, wherein if there is at least one of the channels which fails to satisfy the target BLER, the height weight value is changed to a value corresponding to a lower BLER.

12. The method of claim 9, wherein the step of measuring the BLER comprises:
setting a window of a certain size for storing the CRC results;
detecting the number of CRC errors or an interval between block errors in the window; and
measuring a BLER of each channel with reference to the detected number of CRC errors or the interval between block errors.

13. The method of claim 8, wherein when the TTI of each transport channel is different, the target SIR is determined at a time point when each CRC result is obtained.
